(19) United States
(12) Patent Application Publication
(10) Pub. No.: US 2024/0330642 A1
(43) Pub. Date: Oct. 3, 2024

(54) Composite biological-electronic system whose immediate, dual function is the storing and retrieving of organically encrypted, virtually limitless quantities of information through the use of neural cell colonies fused to electronic input-and-retrieval nodes

(71) Applicants: Michael Miatti, Hawthorne, CA (US); Kaio Miatti, Hawthorne, CA (US)

(72) Inventors: Michael Miatti, Hawthorne, CA (US); Kaio Miatti, Hawthorne, CA (US)

(21) Appl. No.: 18/170,233

(22) Filed: Apr. 3, 2023

(51) Int. Cl. G06N 3/00

(52) U.S. Cl. CPC G06N 3/002

(57) ABSTRACT

A composite biological-electronic system in which neural cells are ambiented within a bio-electronically enriched environment that nurtures, monitors, and trains their development and wellness. The tutoring ambient is connected to a system of information encryptors and decryptors, nodes that feed and retrieve analog or electronic information toward, and from, the (n)fora. The ambient is the launching as well as the receiving platform toward or from the (n)fora, whereas it transforms information into (n)formation through (n)foric processes and conversely receives and translates the incoming (n)foraic flow into human-processable information. Once the information has been decrypted at the output end, it is digitized for computerized use and further dissemination.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A LARGE TABLE, OR A COMPUTER PROGRAM LISTING APPENDIX ON READ-ONLY OPTICAL DISK

Not Applicable.

### BACKGROUND OF THE INVENTION

In its fundamental form, information is not energy nor is it matter, as physicist Norbert Wiener had postulated and subsequently, demonstrated. As such, and in order to exist independently of energy and matter, information resides in, or resonates with, a foundational state of the universe, the (n)fora. Neurological systems, such as the human brain, have developed the capacity to consciously, subconsciously or unconsciously inculcate and extricate information in, and from the (n)fora.

By inserting man-made controllers in the continuous information exchange processes between neural cells and the (n)fora, our invention will be capable of storing and retrieving limitless quantities of information.

The four fundamental problems of the various technologies and related media used throughout humanity's evolution with the purpose to storing and retrieving information are:

Limited capacity, Obsolescence, Limited scope, Data security

When it comes to expressing the capacity of any information storing systems invented by man, one could use any numeral in order to express it, but in the end, it is a finite number. Our invention has the potential to store and retrieve unlimited quantities of information.

Historically, the information storing systems that humanity has used, be it stone or clay tablets, papyruses, books, film, magnetic or digital media, even “the cloud”, are subjected to gradual or sudden deterioration through time and finally, to physical obliteration. Our invention stores the information directly in the (n)fora, where it remains deposited well beyond humanity's existence horizon. Viewed through this prism, it can be also be understood as “information teleportation”, but this particular consideration is beyond this patent's purview.

No man-made information system was, until now, capable to storing subjective values, such as volitional characteristics, although they are part of our individual and collective experience and therefore do objectively exist. Our invention shall be capable of storing and retrieving not only quantitative data, but any type of information that the human brain can develop, including subjective, emotional values as well as volitional characteristics.

Using the originating system's particular and unique neural configuration as the “password” for the flows of information, the invention guarantees in fact a quasi-absolute protection from breaching.

### BRIEF SUMMARY OF THE INVENTION

The invention stores and retrieves organically encrypted, virtually limitless quantities of information through the use of neural cell colonies fused to electronic input-and-retrieval nodes.

It encrypts the information straight in the (n)fora, where it resides beyond humanity's time horizon. In and by itself, once stored in the (n)fora thus becoming (n)formation, the data is not subjected to obsolescence nor degradation. It simply and purely exists.

The (n)formation is secure in a manner that is, for all practical purposes, quasi-absolute. What does that mean? Because of the very nature of the way the (n)fora stores it, the information is wholly available only to the original, depositing neural system, or to an exact, neural replica of it. Only while the originator brain cell system is kept alive, or it has been replicated with the absolute same configuration, and only then is it capable of accessing in its entirety the information that it has previously stored in the (n)fora.

Thirdly, the (n)fora's bounds are limitless for our matter's concern as it expands by the same rate as the universe's expansion, therefore capable of accommodating any and all information generated in the universe. The relationships between the (n)fora, energy and matter are, again, beyond the scope of the patent's discussion.

### DETAILED DESCRIPTION OF THE INVENTION

In order to actually make the invention, the following steps are necessary:
1. Neural cells are seeded and grown as unit colonies in a controlled environment as “brain units”.
2. From their very inception, the cell cultures are ambiented within a bio-electronically enriched environment that nurtures, monitors, and trains their wellness and development, called the “tutoring ambient”.
3. The tutoring ambient is connected to a system of information encryptors and decryptors, nodes that feed and retrieve analog or electronic information toward, and from, the (n)fora. The ambient is simply a launching or receiving platform toward or from the (n)fora, whereas it transforms information into (n)formation through (n)foric processes (whose exact nature we do not understand) and conversely receives, and in the process translates, the incoming (n)foraic flow into human-processable information.
4. Once the information has been decrypted at the output end, it is digitized for computerized use and further dissemination.

The “brain units” (1) are the main component of the information storing and retrieving system—all data flows through them, although—as this is of utmost importance as it represents the fundamental difference between our invention and all others barred none—it does not reside within the brain units themselves, which are nothing but a conduit for the processes of information storing and retrieving.

Their unique structure thus makes them into the very “key” to the “storing vault”, which is the universal (n)fora.

The neural cells are nested in a ‘tutoring ambient” (2).

The information is supplied to the brain units by a series of analog and electronic encryptors (3) and conversely read at the receiving end by a series of decryptors. The system uses uniformly matching encryptors and decryptors for any specific type of information up-flowing and ebbing through it (4).

The invention allows for an (n)foraic up-flow of information toward the (n)fora, where it is stored, as well as a retrieving counter-flow, the (n)foraic ebbing. The fundamental condition is that, for any given item of information, the up-flowing and ebbing pass through the same brain unit.

The discrete unit of any up-flow or ebb is defined as a “fore”.

Any information item is first translated by an encryptor and electronically fed, under a unique stimulus, to a specialized brain unit. The brain unit does its job and translates, then uploads the information in the (n)fora through the usual way neural systems construct memories. In the process, information becomes (n)formation.

In order to retrieve a “fore” the original stimulus is applied to the brain unit. As the brain unit is activated, it retrieves the “fore” which at that level becomes information readable by a decryptor associated with that specific brain unit, and transposes it for electronic reading.

1. A composite biological-electronic system comprised of neural cell colonies ambiented within a bio-electronically enriched environment and fused to electronic input-and-retrieval nodes for securely storing and retrieving virtually limitless quantities of information into, and from, the (n)fora.
